(19) United States
(12) Patent Application Publication
(10) Pub. No.: US 2025/0369809 A1
(43) Pub. Date: Dec. 4, 2025

(54) STRAIN SENSING STRUCTURE AND METHOD OF FABRICATING THE SAME

(71) Applicants: Avary Holding (Shenzhen) Co., Ltd., Shenzhen (CN); QingDing Precision Electronics (Huai’an) Co., Ltd., Jiangsu Province (CN); Garuda Technology Co., Ltd., New Taipei City (TW)

(72) Inventors: Hsiao-Ting HSU, Shenzhen (CN); Fu-Yun SHEN, Shenzhen (CN); Shi-Xiang LV, Shenzhen (CN); Ya-Huan WU, Shenzhen (CN)

(21) Appl. No.: 18/675,485

(22) Filed: May 28, 2024

(51) Int. Cl. G01L 1/22

(52) U.S. Cl. CPC G01L 1/2287

(57) ABSTRACT

A strain sensing structure and a fabricating method of the same are provided. The strain sensing structure includes a flexible substrate, strain resistor members, a first wiring layer and a second wiring layer. The flexible substrate has through holes which are distributed separately. The strain resistor members are respectively disposed in the through holes. The first wiring layer is stacked on an upper side of the flexible substrate and includes first wirings, where the first wirings are separate from each other. The second wiring layer is stacked on a lower side of the flexible substrate and includes second wirings, where the second wirings are separate from each other. Each strain resistor member is electrically connected to one of the first wirings and one of the second wirings, so that the strain resistor members form a series circuit through the first wirings and the second wirings.

### BACKGROUND

### Field of Invention

The present application relates to a strain sensor and a method of fabricating the same. More particularly, the present application relates to a strain sensing structure and a method of fabricating the same for measuring the stress in a direction which is perpendicular to its setting surface where the strain sensing structure is disposed.

### Description of Related Art

The strain sensor is a device which is used to measure the deformation of an object and the stress applied to the object. The strain sensor can convert the stress applied to the object into electrical signals for output, so that the strain sensor could be applicable in fields such as human movement detection, human-computer interaction, engineering structure detection. The strain sensor such as a strain gauge is disposed on the setting surface of the object under test in use and is able to measure the stress applied to the object by variations in resistance. However, the strain sensor is used to measure the stress in a direction which is parallel with the setting surface and does not directly measure the stress in a direction which is perpendicular to the setting surface. Therefore, it needs complex computation to obtain the stress in the direction perpendicular to the setting surface.

### SUMMARY

At least one embodiment of the application provides a strain sensing structure and a method of fabricating the same, in which the strain sensing structure could directly measure the stress in the direction which is perpendicular to a setting surface where the strain sensing structure is disposed.

The strain sensing structure provided by the at least one embodiment of the application includes a flexible substrate, multiple strain resistor members, a first wiring layer and a second wiring layer. The flexible substrate has multiple through holes, in which the through holes are distributed separately. The strain resistor members are respectively disposed in the through holes. The first wiring layer is stacked on an upper side of the flexible substrate and includes multiple first wirings, in which the first wirings are separate from each other. The second wiring layer is stacked on a lower side of the flexible substrate and includes multiple second wirings, in which the second wirings are separate from each other. Each of the strain resistor members is electrically connected to one of the first wirings and one of the second wirings, so that the strain resistor members form a series circuit through the first wirings and the second wirings.

The fabricating method of the strain sensing structure provided by the at least one embodiment of the application includes: providing a first flexible base board, in which the first flexible base board includes a flexible dielectric layer and a first metal layer, and the flexible dielectric layer and the first metal layer in stacks; patterning the first metal layer to form a first wiring layer, so that the first flexible base board forms a first flexible wiring board, in which the first wiring layer includes first wirings which are separate from each other; providing a second flexible base board, in which the second flexible base board includes a flexible substrate and a second metal layer, and the flexible substrate and the second metal layer in stacks; patterning the second metal layer to form a second wiring layer, in which the second wiring layer includes second wirings which are separate from each other; forming through holes in the flexible substrate, so that the second flexible base board forms a second flexible wiring board; disposing a strain resistor material to the through holes, in which the strain resistor material directly touches the second wirings; and connecting the first flexible wiring board and the second flexible wiring board to make the strain resistor material become strain resistor members, in which the strain resistor members form a series circuit through the first wirings and the second wirings.

The fabricating method of the strain sensing structure provided by the at least one embodiment of the application includes: providing a flexible base board, in which the flexible base board includes a flexible substrate, a first metal layer and a second metal layer, and the flexible substrate is stacked between the first metal layer and the second metal layer; patterning the first metal layer to form a first wiring layer, in which the first wiring layer includes first wirings which are separate from each other; patterning the second metal layer to form a second wiring layer, in which the second wiring layer includes second wirings which are separate from each other; forming through holes in the first wiring layer and the flexible substrate; disposing a strain resistor material to the through holes, in which the strain resistor material directly touches the first wirings and the second wirings; and making the strain resistor material become strain resistor members, in which the strain resistor members form a series circuit through the first wirings and the second wirings.

Based on the above, in the strain sensing structures applied for above embodiments, the structures of the strain resistor members are easy to cause volume variations in a direction (perpendicular direction) which is perpendicular to the setting surfaces where the strain sensing structures are disposed, thus directly measuring the stress in perpendicular direction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of a strain sensor according to at least one embodiment of the application.

FIG. 2 is a partial cross-sectional diagram along line I-I′ in FIG. 1.

FIGS. 3A and 3B are a schematic diagram corresponding to a strain resistor member in FIG. 2 and a schematic diagram corresponding to microstructures of the strain resistor member in FIG. 2, respectively.

FIGS. 4A and 4B are a schematic diagram illustrating the strain resistor member stressed in FIG. 3A and a schematic diagram illustrating the microstructures of the strain resistor member stressed in FIG. 3B, respectively.

FIG. 5 is a perspective view of a strain sensor according to another embodiment of the application.

FIG. 6 is a top view of a strain sensor according to another embodiment of the application.

FIGS. 7A and 7B are a schematic diagram and a circuit diagram of a strain sensor according to another embodiment of the application, respectively.

FIGS. 8A and 8B are a schematic diagram and a circuit diagram of a strain sensor according to another embodiment of the application, respectively.

FIGS. 9A and 9B are a schematic diagram and a circuit diagram of a strain sensor according to another embodiment of the application, respectively.

FIG. 10 is a partial cross-sectional diagram of a strain sensing structure according to another embodiment of the application.

FIG. 11 is a partial cross-sectional diagram of a strain sensing structure according to another embodiment of the application.

FIG. 12A is a partial cross-sectional diagram of a step of forming a flexible wiring board of a fabricating method in fabricating the strain sensing structure in FIG. 2.

FIG. 12B is a partial cross-sectional diagram of a step of forming a flexible wiring board and disposing a strain resistor material of the fabricating method in fabricating the strain sensing structure in FIG. 2.

FIG. 12C is a partial cross-sectional diagram of a step of connecting the flexible wiring boards of the fabricating method in fabricating the strain sensing structure in FIG. 2.

FIG. 13A is a partial cross-sectional diagram of a step of forming a flexible wiring board of a fabricating method in fabricating the strain sensing structure in FIG. 11.

FIG. 13B is a partial cross-sectional diagram of a step of becoming strain resistor members and covering a cover layer of the fabricating method in fabricating the strain sensing structure in FIG. 11.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following description, in order to clearly present the technical features of the present disclosure, the dimensions (such as length, width, thickness, and depth) of elements (such as layers, films, substrates, and areas) in the drawings will be enlarged in unusual proportions, and the quantity of some elements will be reduced. Accordingly, the description and explanation of the following embodiments are not limited to the quantities, sizes and shapes of the elements presented in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case which are mainly for illustration are intended neither to accurately depict the actual shape of the elements nor to limit the scope of patent applications in this case. In addition, some diagrams show the Cartesian coordinate system (a rectangular coordinate system including directions X,Y and Z (three axes)) to illustrate the technical features of the application.

Moreover, the words, such as “about”, “approximately”, or “substantially”, appearing in the present disclosure not only cover the clearly stated values and ranges, but also include permissible deviation ranges as understood by those with ordinary knowledge in the technical field of the invention. The permissible deviation range can be caused by the error generated during the measurement, where the error is caused by such as the limitation of the measurement system or the process conditions. In addition, “about” may be expressed within one or more standard deviations of the values, such as within ±30%, ±20%, ±10%, or ±5%. The word “about”, “approximately” or “substantially” appearing in this text can choose an acceptable deviation range or a standard deviation according to optical properties, etching properties, mechanical properties or other properties, not just one standard deviation to apply all the optical properties, etching properties, mechanical properties and other properties. In addition, in order to clearly illustrate following examples, the components with the same or similar features are denoted by the same reference characters.

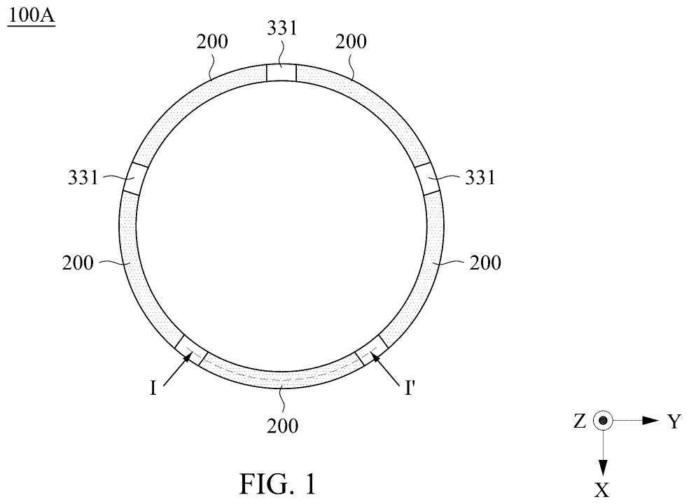

FIG. 1 is a top view of a strain sensor 100A according to at least one embodiment of the application. Referring to FIG. 1, the strain sensor 100A is located on the X-Y plane and could be used for measuring the stress in a direction parallel to the direction Z (vertical direction in FIG. 1). The strain sensor 100A is formed by multiple resistor chains 200 in series connections. The shape formed by the resistor chains 200 in series connections may be a straight line, a curve, a closed ring, or an unclosed ring (such as a C-shaped ring), but the embodiments of the application are not limited thereto. Specially, the resistor chains 200 which are in the ring shape may be disposed on human wearables and fit human bodies more easily to sense. For example, the strain sensor 100A is formed by five resistor chains 200 in series connections, and the resistor chains 200 form a circular shape. In addition, the length of each resistor chain 200 is related to its total equivalent resistance. The lengths of the resistor chains 200 may be same or different.

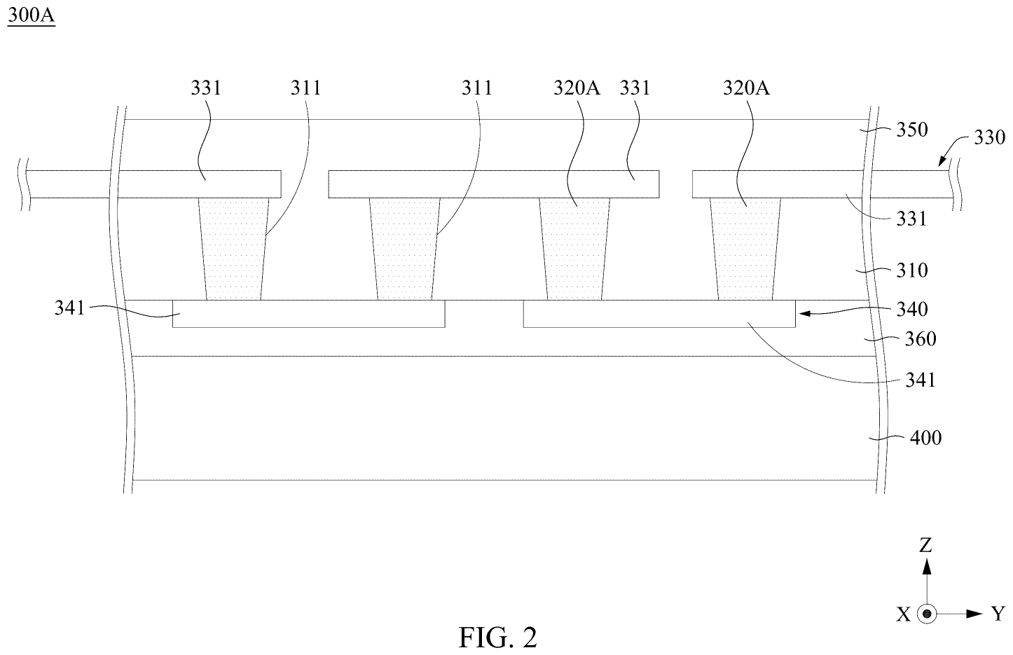

FIG. 2 is a partial cross-sectional diagram along line I-I′ in FIG. 1, and FIG. 2 illustrates one of the resistor chains 200 in FIG. 1. Referring to FIGS. 1 and 2, the resistor chains 200 are composed of a strain sensing structure 300A, and the strain sensing structure 300A includes a flexible substrate 310, multiple strain resistor members 320A, a wiring layer 330, a wiring layer 340, a flexible dielectric layer 350 and a cover layer 360. The flexible substrate 310 may be made of thermoplastic materials with tensile modulus less than 3700 Mpa, such as 2250 Mpa, so that the stressed flexible substrate 310 avoids too small deformation and thus cause deformation sensitivity well.

The materials of the flexible substrate 310 may be thermoplastics, such as liquid crystal polymer (LCP), polyethylene terephthalate (PET), thermoplastic polyurethane (TPU), polyetheretherketone (PEEK), or thermoplastic elastomer (TPE). The flexible substrate 310 has multiple through holes 311. The through holes 311 are distributed separately. The diameter of each through hole 311 is between 50 and 120 micron meters, and the height of each through hole 311 is between 15 and 60 micron meters.

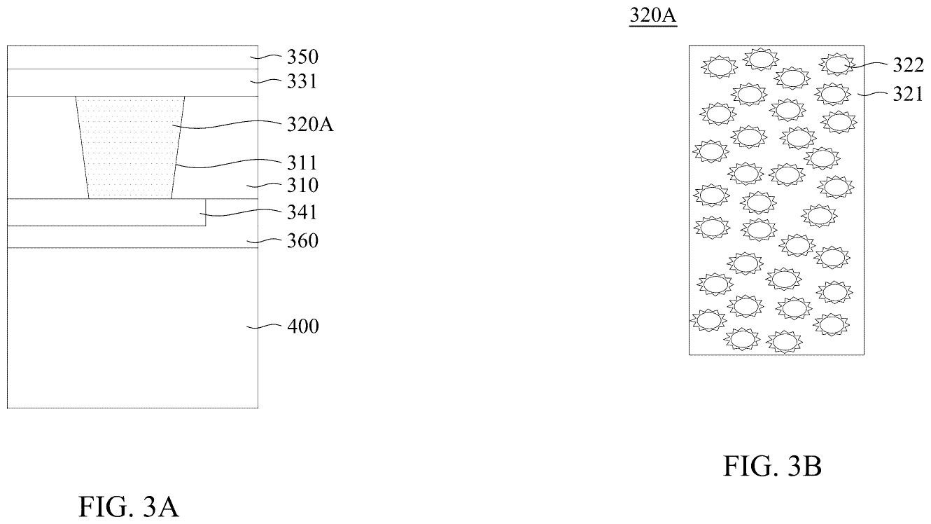

FIGS. 3A and 3B are a schematic diagram corresponding to a strain resistor member 320A in FIG. 2 and a schematic diagram corresponding to microstructures of the strain resistor member in FIG. 2, respectively. Referring to FIGS. 2, 3A and 3B, the strain resistor members 320A are respectively disposed in the through holes 311. Each strain resistor member 320A includes an insulating base substance 321, multiple conductive particles 322 and an additive (not shown). When a total amount of each strain resistor member 320A is 100 wt %, an usage amount of the insulating base substance 321 is between 8 wt % and 15 wt %, and an usage amount of the conductive particles 322 is between 85 wt % and 90 wt %, and an usage amount of the additive is between 0 wt % and 2 wt %. That is, the usage amount of the insulating base substance 321 is greater than or equal to 8 wt % and is less than or equal to 15 wt %. The usage amount of the conductive particles 322 is greater than or equal to 85 wt % and is less than or equal to 90 wt %. The usage amount of the additive is greater than or equal to 0 wt % and is less than or equal to 2 wt %.

The insulating base substance 321 includes at least one of epoxy resin, phosphosilicate glass (PSG), thermoplastic polyurethane, polyester, polydimethylsiloxane (PDMS) and silicone. The conductive particles include at least one of copper, silver, nickel, indium tin oxide, zinc oxide and ruthenium dioxide. The additive may be a curing agent and/or a dispersant.

The curing agent may be a latent hardener. For example, the curing agent with epoxy resin at room temperature has stability. The epoxy resin can be cured by irradiation, heating, or other means. The curing agent may be hydrazide, aliphatic amine, alicyclic amine, aromatic amine, polyamide or organic acid anhydride. The dispersant may be polymer dispersant, nonionic surfactant, anionic surfactant, cationic surfactant or amphoteric surfactant.

The wiring layer 330 is stacked on an upper side of the flexible substrate 310. The materials of the wiring layer 330 may be copper or silver, and the thickness of the wiring layer 330 may be between 12 and 18 micron meters. The wiring layer 330 includes multiple wirings 331 which are separate from each other. The wiring layer 340 is stacked on a lower side of the flexible substrate 310. The materials of the wiring layer 340 may be copper or silver, and the thickness of the wiring layer 340 may be between 12 and 18 micron meters. The wiring layer 340 includes multiple wirings 341 which are separate from each other. Each strain resistor member 320A is electrically connected to one of the wirings 331 and one of the wirings 341 and is electrically connected to one of the adjacent strain resistor members 320A and another one of the adjacent strain resistor members 320A by the wiring 331 and the wiring 341. Therefore, the strain resistor members 320A form a series circuit through the wirings 331 and the wirings 341.

The flexible dielectric layer 350 is stacked on the wiring layer 330. The material of the flexible dielectric layer 350 may be similar to the material of the flexible substrate 310. The flexible dielectric layer 350 may be made of thermoplastic materials with tensile modulus less than 3700 Mpa. In addition, the flexible dielectric layer 350 may also be stacked on the wiring layer 340, but the embodiments of the application are not limited thereto.

The cover layer 360 may cover the wiring layer 330 or the wiring layer 340, but the embodiments of the application are not limited thereto. For example, the cover layer 360 covers the wiring layer 340. The water absorption rate of the cover layer 360 may be less than 0.2%. The materials of the cover layer 360 may be polyimide or polytetrafluoroethylene.

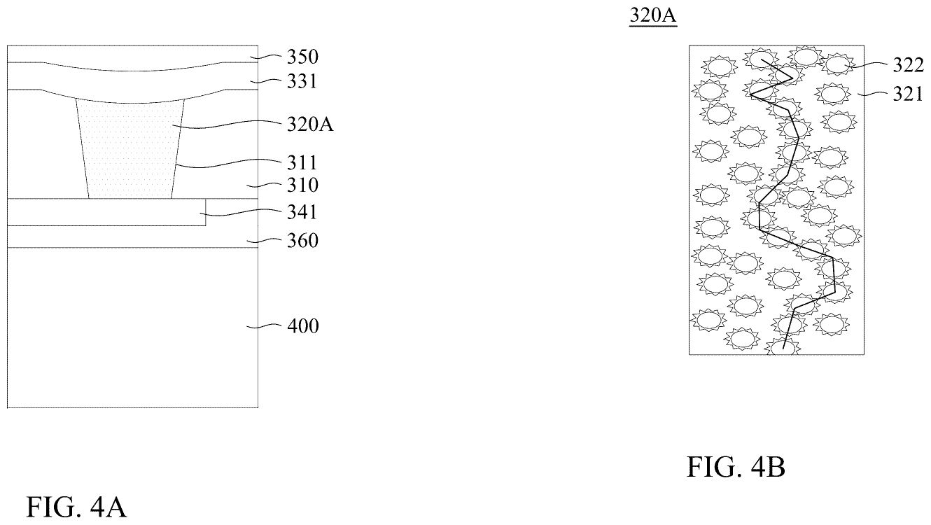

FIGS. 4A and 4B are a schematic diagram illustrating the strain resistor member 320A stressed in FIG. 3A and a schematic diagram illustrating the microstructures of the strain resistor member 320A stressed in FIG. 3B, respectively. Referring to FIGS. 3A, 3B, 4A and 4B, the strain resistor member 320A has electric resistance which is variable according to the stress applied to the strain resistor member 320A. Specially, the electric resistance is inversely proportional to the area of the cross section of the strain resistor member 320A (the section parallel to the X-Y plane) and is proportional to the height of the strain resistor member 320A (parallel to the direction Z). In addition, resistivity of the electric resistance is also related to the materials of the strain resistor member 320A. In detail speaking, when the strain resistor member 320A receives the external electric potential and is applied to the stress (parallel direction Z), the distances of the conductive particles 322 in the strain resistor member 320A shorten each other to raise the probability for quantum tunneling effects happening, thereby raising the tunneling currents and varying the electric resistance.

Further, the magnitude of the stress is proportional to the magnitude of the tunneling currents and is inversely proportional to the magnitude of the electric resistance, so that the strain resistor member 320A could measure the magnitude of the stress. In addition, at least some conductive particles 322 touch the wirings 331 or the wirings 341, thereby increasing the sensitivity in varying the electric resistance when the strain resistor member 320A is stressed.

Referring to FIGS. 1 and 2, the strain resistor members 320A are electrically connected in series through the wirings 331 and the wirings 341 to form one resistor chain 200, in which 20 to 200 strain resistor members 320A could be electrically connected in series in one resistor chain 200 to form a variable resistor of which the electric resistance is variable in a range from 10 ohms to 3000 ohms. The resistor chains 200 may be electrically connected through the wirings 331 or the wirings 341, further, or through other conductive structures which are independent from the strain sensing structure 300A, but the embodiments of the application are not limited thereto. In FIG. 1, the resistor chains 200 are electrically connected through the wirings 331 to form the circular shape, and a radian corresponding to each wiring 331 between adjacent two of the resistor chains 200 may correspond to a central angle between 3 and 15 degrees of the circular shape.

Specially, in the same resistor chain 200, because the strain resistor members 320A constitute resistor structures extending (parallel to the measured direction Z) along the direction Z (perpendicular direction), and the electric resistance of the strain resistor members 320A is in electrical series connection (accumulating the electric resistance), the applied stress with same directions and magnitudes but at different positions on the X-Y plane also makes the resistor chain 200 generate the same resistance variations. Accordingly, the resistor chain 200 can directly measure the stress in perpendicular direction (direction Z), so that measuring results do not need complicated calculations but are outputted instantly. In other words, when the resistor chain 200 receives the stress in the direction Z, the structures of the strain resistor members 320A are easy to cause volume variations in the direction Z and thus directly measure the stress in the direction Z in coordination with a configuration of the series circuit.

It is necessary to explain that the strain sensing structure 300A may be disposed on a hard carrier 400 to measure the object under test more easily. Under the support of the hard carrier 400, the strain sensing structure 300A may be easy to measure the stress in perpendicular direction. The hard carrier 400 may be a stainless steel plate or a fiberglass plate.

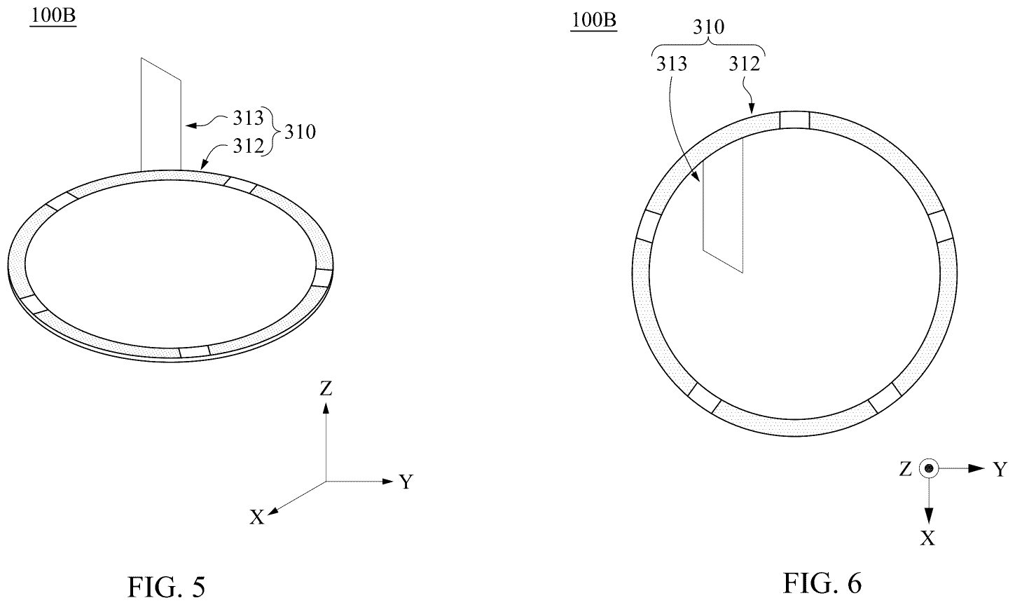

FIG. 5 is a perspective view of a strain sensor 100B according to another embodiment of the application, and FIG. 6 is a top view of the strain sensor 100B according to another embodiment of the application. Referring to FIGS. 2, 5 and 6, the strain sensor 100B is similar to the strain sensor 100A in FIG. 1, and the difference between the strain sensor 100B and the strain sensor 100A is that the flexible substrate 310 of the strain sensor 100B has a sensing area 312 and a non-sensing area 313. The strain resistor members 320A are just disposed in the through holes 311 located in the sensing area 312. The wiring layer 330, the wiring layer 340, the flexible dielectric layer 350 and the cover layer 360 may also be stacked on the flexible substrate 310 in the non-sensing area 313.

The flexible substrate 310 in the non-sensing area 313 may be at right angle to the flexible substrate 310 in the sensing area 312 (as shown in FIG. 5), or may be folded below or above the flexible substrate 310 in the sensing area 312 (as shown in FIG. 6). The wiring layers 330 and 340 in the non-sensing area 313 may be electrically connected to other circuit boards or modules, further, so that the application for the strain sensor 100B is more extensive. It is necessary to explain that the strain resistor members 320A in the sensing area 312 stand apart from the fold (between the sensing area 312 and the non-sensing area 313) at least greater than 0.1 mm without influencing the folds of the flexible substrate 310 in the non-sensing area 313.

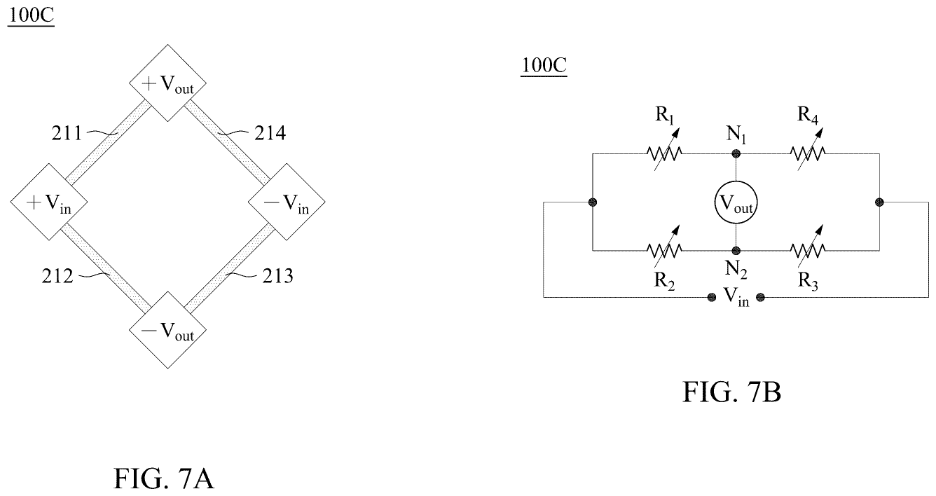

FIGS. 7A and 7B are a schematic diagram and a circuit diagram of a strain sensor 100C according to another embodiment of the application, respectively. The strain sensor 100C may form at least one of Wheatstone Bridges. Referring to FIGS. 7A and 7B, the strain sensor 100C forms the Wheatstone Bridge through four resistor chains 211˜214. The resistor chain 211 equivalent to resistor R₁ and the resistor chain 214 equivalent to resistor R₄ are electrically connected in series, and the resistor chain 212 equivalent to resistor R₂ and the resistor chain 213 equivalent to resistor R₃ are electrically connected in series. The resistor chains 211 and 214 in series, the resistor chains 212 and 213 in series and the input voltage Vᵢₙ are connected in parallel.

There is a first node N₁ between the resistor R₁ and the resistor R₄ (between the resistor chains 211 and 214), and there is a second node N₂ between the resistor R₂ and the resistor R₃ (between the resistor chains 212 and 213). The electric potential difference between the first node N₁ and the second node N₂ is set to the output voltage Vₒᵤₜ. For example, the output voltage Vₒᵤₜ may be zero when the strain sensor 100C is not applied to the stress; the output voltage Vₒᵤₜ may not be zero when the strain sensor 100C is applied to the stress.

In this way, by forming the Wheatstone Bridge via the strain sensor 100C, the resistor chains 211˜214 generate resistance variations in sensing the stress, so that the output voltage Vₒᵤₜ changes, thereby achieving precise measurements. It should be noted that at least one of the resistor chains 211˜214 may also be replaced by at least one resistor which has a fixed resistance value, but the embodiments of the application are not limited thereto. In addition, multiple strain sensors 100C (forming multiple Wheatstone Bridges) may be disposed on the same object to perform measurements in different positions on the setting surface.

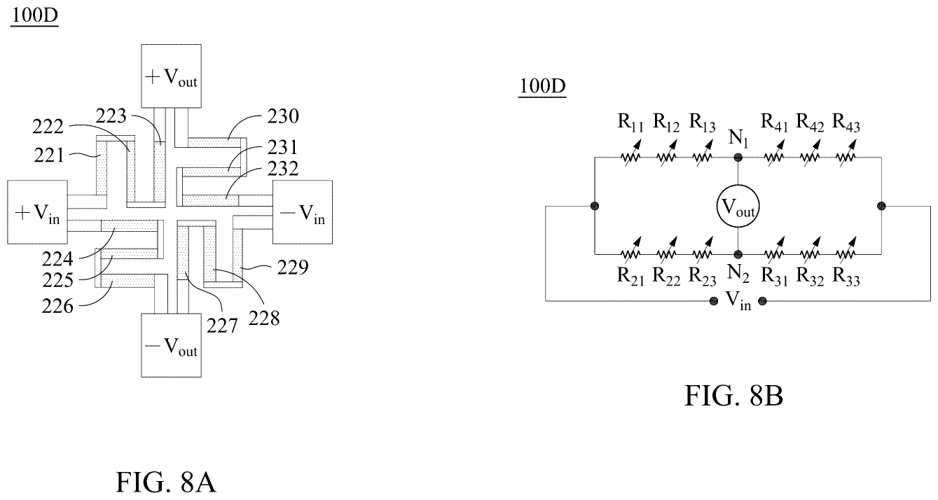

FIGS. 8A and 8B are a schematic diagram and a circuit diagram of a strain sensor 100D according to another embodiment of the application, respectively. Referring to FIGS. 8A and 8B, the strain sensor 100D forms the Wheatstone Bridge through twelve resistor chains 221˜232. The resistor chains 221˜223 and 230˜232 respectively equivalent to resistors R₁₁, R₁₂, R₁₃, R₄₁, R₄₂ and R₄₃ are electrically connected in series, and the resistor chains 224˜226 and 227˜229 respectively equivalent to resistors R₂₁, R₂₂, R₂₃, R₃₁, R₃₂ and R₃₃ are electrically connected in series. The resistor chains 221˜223 and 230˜232 in series, the resistor chains 224˜226 and 227˜229 in series and the input voltage Vᵢₙ are connected in parallel. Similar to FIGS. 7A and 7B, the electric potential difference between a first node N₁ and a second node N₂ is set to the output voltage Vₒᵤₜ. In this way, the resistor chains 221˜223 and 230˜232 in series and the resistor chains 224˜226 and 227˜229 in series increase equivalent resistance values, thereby promoting the sensitivity for measurements of the strain sensor 100D.

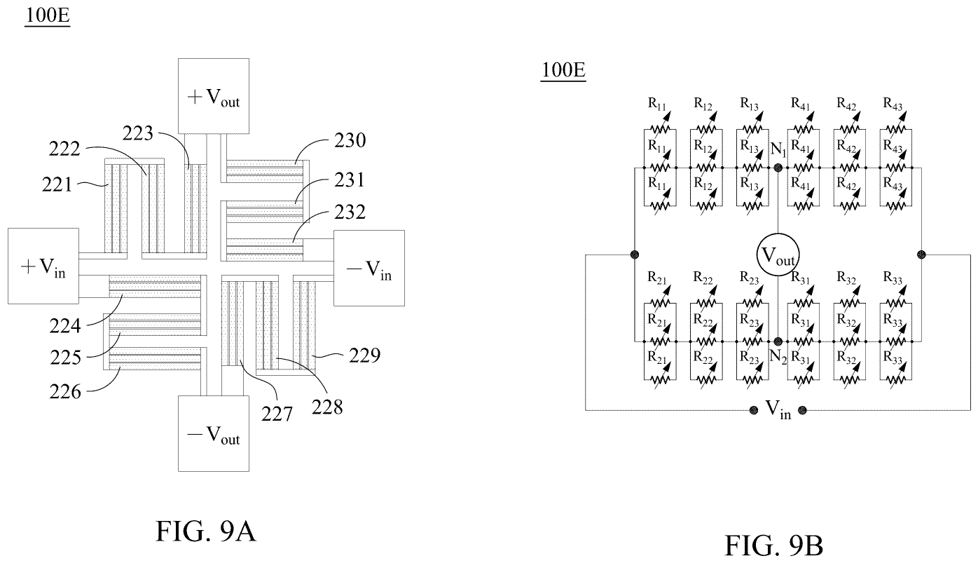

FIGS. 9A and 9B are a schematic diagram and a circuit diagram of a strain sensor 100E according to another embodiment of the application, respectively. Referring to FIGS. 9A and 9B, the strain sensor 100E is similar to the strain sensor 100D in FIGS. 8A and 8B, and the difference between the strain sensor 100E and the strain sensor 100D is that the strain sensor 100E forms the Wheatstone Bridge through thirty six resistor chains 221˜232. Three resistor chains 221 are electrically connected in parallel, and three resistor chains 222 are electrically connected in parallel, and three resistor chains 223 are electrically connected in parallel. The resistor chains 221 in parallel, the resistor chains 222 in parallel and the resistor chains 223 in parallel are electrically connected in series. Similarly, three resistor chains 224 in parallel, three resistor chains 225 in parallel and three resistor chains 226 in parallel are electrically connected in series. Three resistor chains 227 in parallel, three resistor chains 228 in parallel and three resistor chains 229 in parallel are electrically connected in series. Three resistor chains 230 in parallel, three resistor chains 231 in parallel and three resistor chains 232 in parallel are electrically connected in series.

Similar to FIGS. 8A and 8B, the resistor chains 221˜223 and 230˜232 in series, the resistor chains 224˜226 and 227˜229 in series and the input voltage Vᵢₙ are connected in parallel. The electric potential difference between a first node N₁ and a second node N₂ is set to the output voltage Vₒᵤₜ. In this way, the strain sensor 100E increases the number of the resistor chains 221˜232 through a parallel circuit, thereby increasing sensing areas. It can be seen from the above Wheatstone Bridge embodiments, the resistor chains 211˜214 or 221˜232 of the strain sensor 100C, 100D or 100E may have different configurations according to sizes of the setting surfaces of the objects and sensitivities for measurements, but the embodiments of the application are not limited thereto.

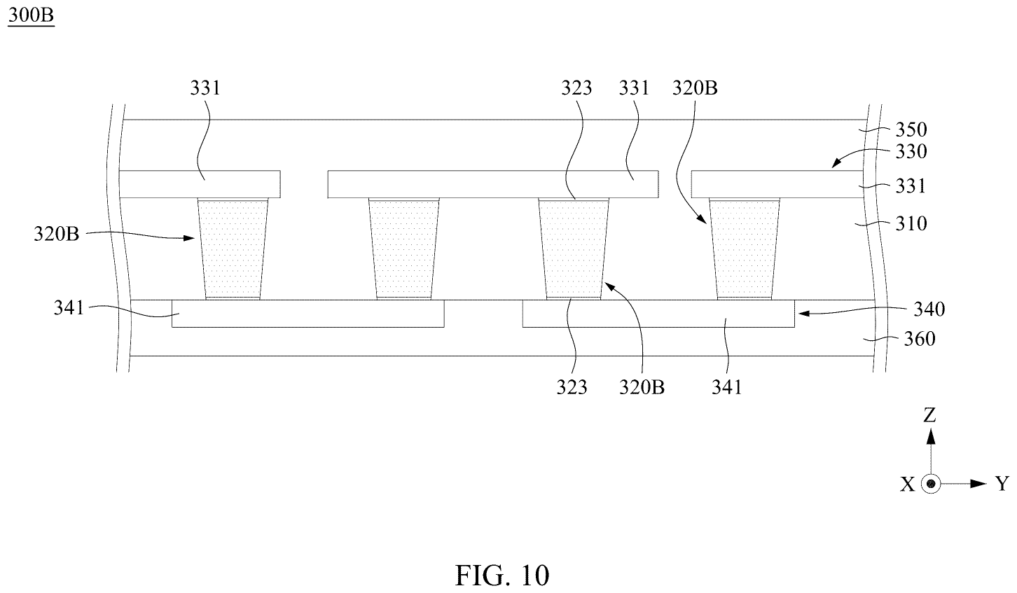

FIG. 10 is a partial cross-sectional diagram of a strain sensing structure 300B according to another embodiment of the application. Referring to FIG. 10, the strain sensing structure 300B is similar to the strain sensing structure 300A in FIG. 2, and the differences between the strain sensing structure 300B and the strain sensing structure 300A are that the conductive particles 322 (in FIG. 4B) further include few low melting metals, such as bismuth, tin, lead and/or indium. Each strain resistor member 320B of the strain sensing structure 300B further includes multiple alloy films 323. The alloy films 323 respectively touch the wiring layers 330 and 340. Specially, due to doping the low melting metals in the conductive particles 322, the alloy films 323 are formed in the strain resistor members 320B when the strain resistor members 320B are formed.

In coordination with referring to FIGS. 4A and 4B, similar to the strain resistor members 320A, when receiving the external electric potential and applied to the stress (parallel direction Z), the conductive particles 322 in the strain resistor member 320B also raise the probability for quantum tunneling effects happening to raise the tunneling currents, thereby varying the electric resistance. The alloy films 323 respectively touch the wiring layers 330 and 340 to block touches between the conductive particles 322 and the wirings 331 and 341, thereby promoting the mechanical properties of the strain sensing structure 300B. That is, the alloy films 323 increase the structural strength of the strain resistor member 320B, thereby extending periods for use of the strain sensing structure 300B.

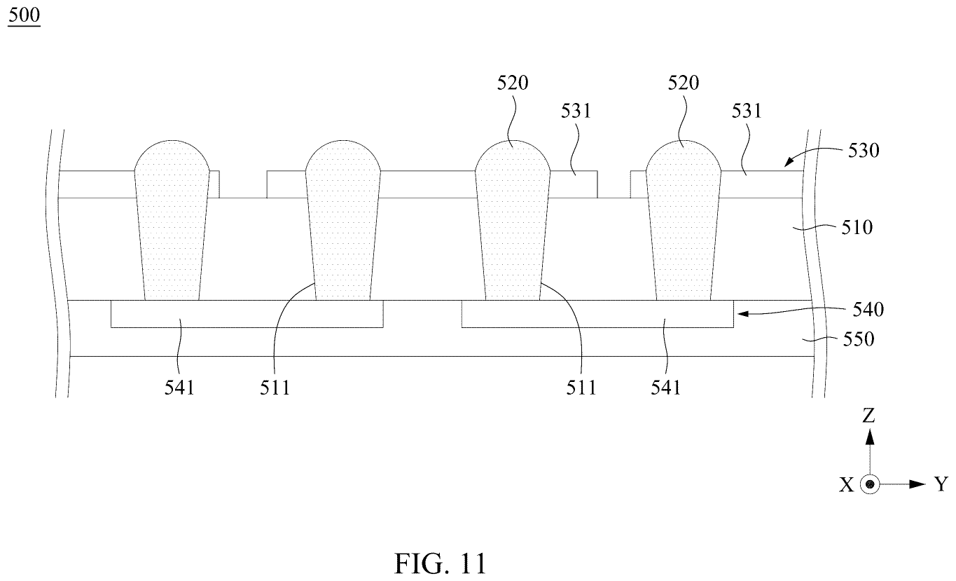

FIG. 11 is a partial cross-sectional diagram of a strain sensing structure 500 according to another embodiment of the application. Referring to FIG. 11, the strain sensing structure 500 includes a flexible substrate 510, multiple strain resistor members 520, a wiring layer 530, a wiring layer 540 and a cover layer 550. The wiring layer 530 and the wiring layer 540 are respectively stacked on an upper side and a lower side of the flexible substrate 510. The flexible substrate 510 has multiple through holes 511, in which the through holes 511 are distributed separately and may extend to pass through the wiring layer 530 or the wiring layer 540, but the embodiments of the application are not limited thereto. For example, the through holes 511 extend to pass through the wiring layer 530. The wiring layer 530 includes multiple wirings 531, and the wirings 531 are also separate from each other. The wiring layer 540 includes multiple wirings 541, and the wirings 541 are also separate from each other.

The strain resistor members 520 are respectively disposed in the through holes 511 and touch the wiring layer 530 and 540. Similar to the strain resistor members 320A in FIG. 2, each strain resistor member 520 is electrically connected to one of the wirings 531 and one of the wirings 541. The strain resistor members 520 also form a series circuit through the wirings 531 and the wirings 541. The cover layer 550 may cover the wiring layer 530 or 540, but the embodiments of the application are not limited thereto. For example, the cover layer 550 covers the wiring layer 540.

The materials of the flexible substrate 510 may be similar to the materials of the flexible substrate 310 in FIG. 2, and may also be thermosetting plastics, such as polyimide (PI), polytetrafluoroethylene (PTFE) or polyamide (PA). The materials of the strain resistor members 520 may be similar to the materials of the strain resistor members 320A in FIG. 2 or the materials of the strain resistor members 320B in FIG. 10. For example, the materials of the strain resistor members 520 are similar to the materials of the strain resistor members 320A in FIG. 2 without alloy films. The materials of the wiring layers 530 and 540 may be similar to the wiring layers 330 and 340 in FIG. 2, respectively. The materials of the cover layer 550 may be similar to the cover layer 360 in FIG. 2. The resistor chains formed by the strain resistor members 520 also measure the stress in the direction (the direction Z) perpendicular to the X-Y plane obtained without complicated calculations.

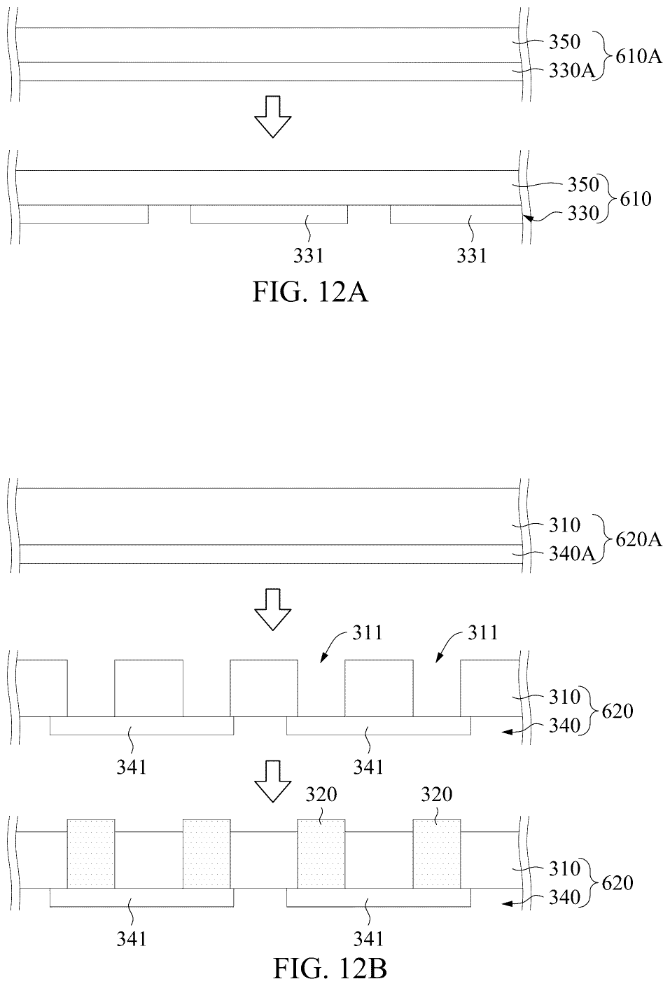

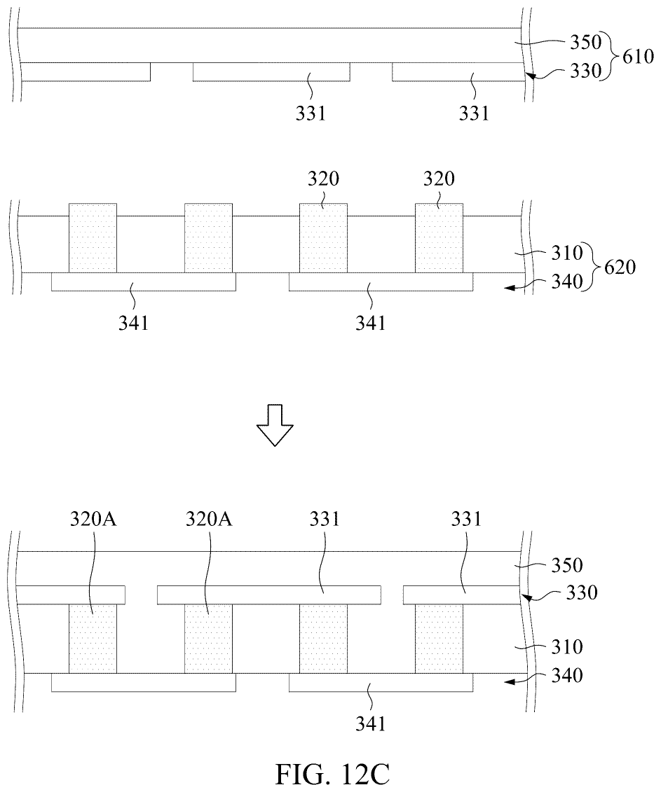

FIG. 12A is a partial cross-sectional diagram of a step of forming a flexible wiring board 610 of a fabricating method in fabricating the strain sensing structure 300A in FIG. 2. Referring to FIG. 12A, at first, provide a flexible base board 610A, in which the flexible base board 610A includes the flexible dielectric layer 350 and a metal layer 330A. The flexible dielectric layer 350 and the metal layer 330A are in stack. The flexible base board 610A may be a single-sided flexible copper clad laminate (FCCL). Then, pattern the metal layer 330A to form the wiring layer 330 which includes the wirings 331 separate from each other, so that the flexible base board 610A forms the flexible wiring board 610.

FIG. 12B is a partial cross-sectional diagram of a step of forming a flexible wiring board 620 and disposing a strain resistor material 320 of the fabricating method in fabricating the strain sensing structure 300A in FIG. 2. Referring to FIG. 12B, at first, provide a flexible base board 620A, in which the flexible base board 620A includes the flexible substrate 310 and a metal layer 340A. The flexible substrate 310 and the metal layer 340A are in stack. The flexible base board 620A may also be a single-sided flexible copper clad laminate. Then, pattern the metal layer 340A to form the wiring layer 340 which includes the wirings 341 separate from each other. Form the through holes 311 penetrating the flexible substrate 310, so that the flexible base board 620A forms the flexible wiring board 620. For example, the through holes 311 can be formed penetrating the flexible substrate 310 by laser drilling. Then, dispose the strain resistor material 320 to the through holes 311, so that the strain resistor material 320 directly touches the wirings 341. For example, the strain resistor material 320 is in the form of paste and coats the through holes 311 via screen printing.

FIG. 12C is a partial cross-sectional diagram of a step of connecting the flexible wiring boards 610 and 620 of the fabricating method in fabricating the strain sensing structure 300A in FIG. 2. Referring to FIG. 12C, make the wiring layer 330 of the flexible wiring board 610 toward the flexible substrate 310 of the flexible wiring board 620. Laminate and heat the flexible wiring boards 610 and 620, so that the flexible wiring boards 610 and 620 connect and the strain resistor material 320 becomes the strain resistor members 320A. Afterward, coat the wiring layer 340 with the cover layer 360 to cover the wiring layer 340 (as shown in FIG. 2). In this way, the fabrication of the strain sensing structure 300A is complete.

It is worth mentioning that a fabricating method of the strain sensing structure 300B in FIG. 10 is similar to the fabricating method of the strain sensing structure 300A in FIG. 2, and the difference between the fabricating method of the strain sensing structure 300B and the fabricating method of the strain sensing structure 300A is that the strain resistor material 320 disposed in the strain sensing structure 300B further includes the few low melting metals, so that junctions of the strain resistor members 320B and the wirings 331 and 341 form the alloy films 323 (in FIG. 10) after laminating and heating the flexible wiring boards 610 and 620.

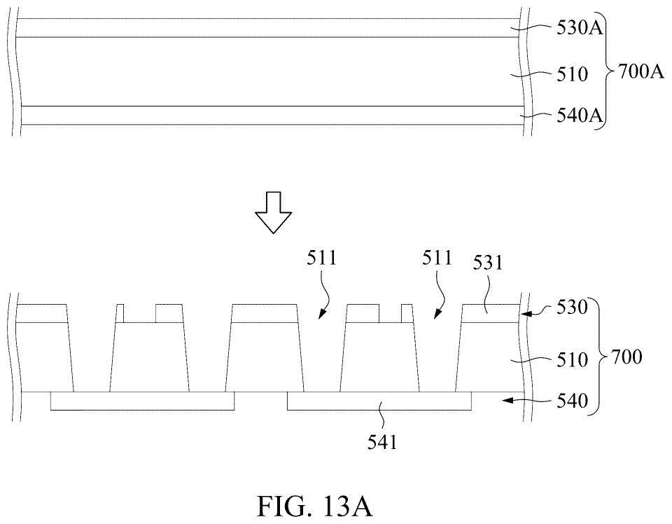

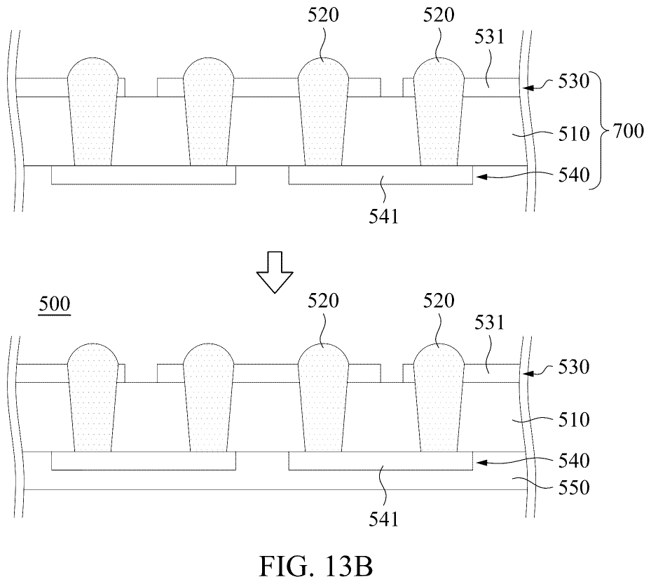

FIG. 13A is a partial cross-sectional diagram of a step of forming a flexible wiring board 700 of a fabricating method in fabricating the strain sensing structure 500 in FIG. 11. Referring to FIG. 13A, at first, provide a flexible base board 700A, in which the flexible base board 700A includes the flexible substrate 510, a metal layer 530A and a metal layer 540A. The flexible substrate 510 is stacked between the metal layers 530A and 540A. The flexible base board 700A may be a double-sided flexible copper clad laminate. Then, pattern the metal layer 530A to form the wiring layer 530 which includes the wirings 531 separate from each other. Pattern the metal layer 540A to form the wiring layer 540 which includes the wirings 541 separate from each other. Form the through holes 511 penetrating the wiring layer 530 and the flexible substrate 510, so that the flexible base board 700A forms the flexible wiring board 700. The through holes 511 may also be formed by laser drilling.

FIG. 13B is a partial cross-sectional diagram of a step of becoming the strain resistor members 520 and covering the cover layer 550 of the fabricating method in fabricating the strain sensing structure 500 in FIG. 11. Referring to FIGS. 13A and 13B, then, dispose a strain resistor material to the through holes 511, and the strain resistor material directly touches the wirings 531 and 541, in which the strain resistor material may protrude the through holes 511. The strain resistor material may also coat the through holes 511 via screen printing. It should be noted that the strain resistor material may include or may not include the few low melting metals, but the embodiments of the application are not limited thereto. Then, heat the flexible wiring board 700, so that the strain resistor material becomes the strain resistor members 520. Then, coat the wiring layer 540 with the cover layer 550 to cover the wiring layer 540. In this way, the fabrication of the strain sensing structure 500 is complete.

Consequently, in the strain sensing structures disclosed from above embodiments, the structures of the strain resistor members are easy to cause volume variations in the directions perpendicular to the setting surfaces where the strain resistor members are disposed, and it is instant for output to directly calculate the applied stress by accumulating the electric resistance in the same resistor chain (formed by the strain resistor members in series), thereby simplifying complicated calculations. In addition, the strain resistor members constitute the resistor structures extending along perpendicular direction, and the strain resistor members do not need occupy too many areas of the setting surfaces to perform measurement, thereby reducing the necessary areas of the setting surfaces, so that the strain sensing structures are appropriate for the objects of small sizes to use.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A strain sensing structure, comprising:
a flexible substrate having a plurality of through holes, wherein the through holes are distributed separately;
a plurality of strain resistor members respectively disposed in the through holes;
a first wiring layer stacked on an upper side of the flexible substrate and comprising a plurality of first wirings, wherein the first wirings are separate from each other; and
a second wiring layer stacked on a lower side of the flexible substrate and comprising a plurality of second wirings, wherein the second wirings are separate from each other,
wherein each of the strain resistor members is electrically connected to one of the first wirings and one of the second wirings, so that the strain resistor members form a series circuit through the first wirings and the second wirings.

2. The strain sensing structure of claim 1, further comprising a flexible dielectric layer, wherein the flexible dielectric layer is stacked on the first wiring layer or the second wiring layer.

3. The strain sensing structure of claim 1, wherein each of the strain resistor members comprises:
an insulating base substance;
a conductive particle; and
an additive,
wherein when a total amount of each of the strain resistor members is 100 wt %, an usage amount of the insulating base substance is between 8 wt % and 15 wt %, an usage amount of the conductive particle is between 85 wt % and 90 wt %, and an usage amount of the additive is between 0 wt % and 2 wt %.

4. The strain sensing structure of claim 3, wherein the insulating base substance comprises at least one of epoxy resin, phosphosilicate glass, thermoplastic polyurethane, polyester, polydimethylsiloxane and silicone.

5. The strain sensing structure of claim 3, wherein the conductive particle comprises at least one of copper, silver, nickel, indium tin oxide, zinc oxide and ruthenium dioxide.

6. The strain sensing structure of claim 5, wherein the conductive particle further comprises at least one of bismuth, tin, lead and indium.

7. The strain sensing structure of claim 1, further comprising a cover layer, wherein the cover layer covers the first wiring layer or the second wiring layer.

8. A fabricating method of a strain sensing structure, comprising:
providing a first flexible base board, wherein the first flexible base board comprises a flexible dielectric layer and a first metal layer, and the flexible dielectric layer and the first metal layer in stacks;
patterning the first metal layer to form a first wiring layer, so that the first flexible base board forms a first flexible wiring board, wherein the first wiring layer comprises a plurality of first wirings which are separate from each other;
providing a second flexible base board, wherein the second flexible base board comprises a flexible substrate and a second metal layer, and the flexible substrate and the second metal layer in stacks;
patterning the second metal layer to form a second wiring layer, wherein the second wiring layer comprises a plurality of second wirings which are separate from each other;
forming a plurality of through holes in the flexible substrate, so that the second flexible base board forms a second flexible wiring board;
disposing a strain resistor material to the through holes, wherein the strain resistor material directly touches the second wirings; and
connecting the first flexible wiring board and the second flexible wiring board to make the strain resistor material become a plurality of strain resistor members, wherein the strain resistor members form a series circuit through the first wirings and the second wirings.

9. The fabricating method of claim 8, further comprising:
covering a cover layer on the first wiring layer or the second wiring layer.

10. The fabricating method of claim 8, wherein each of the strain resistor members comprises:
an insulating base substance;
a conductive particle; and
an additive,
wherein when a total amount of each of the strain resistor members is 100 wt %, an usage amount of the insulating base substance is between 8 wt % and 15 wt %, an usage amount of the conductive particle is between 85 wt % and 90 wt %, and an usage amount of the additive is between 0 wt % and 2 wt %.

11. The fabricating method of claim 10, wherein the insulating base substance comprises at least one of epoxy resin, phosphosilicate glass, thermoplastic polyurethane, polyester, polydimethylsiloxane and silicone.

12. The fabricating method of claim 10, wherein the conductive particle comprises at least one of copper, silver, nickel, indium tin oxide, zinc oxide and ruthenium dioxide.

13. The fabricating method of claim 12, wherein the conductive particle further comprises at least one of bismuth, tin, lead and indium.

14. A fabricating method of a strain sensing structure, comprising:
providing a flexible base board, wherein the flexible base board comprises a flexible substrate, a first metal layer and a second metal layer, and the flexible substrate is stacked between the first metal layer and the second metal layer;
patterning the first metal layer to form a first wiring layer, wherein the first wiring layer comprises a plurality of first wirings which are separate from each other;
patterning the second metal layer to form a second wiring layer, wherein the second wiring layer comprises a plurality of second wirings which are separate from each other;
forming a plurality of through holes in the first wiring layer and the flexible substrate;
disposing a strain resistor material to the through holes, wherein the strain resistor material directly touches the first wirings and the second wirings; and
making the strain resistor material become a plurality of strain resistor members, wherein the strain resistor members form a series circuit through the first wirings and the second wirings.

15. The fabricating method of claim 14, further comprising:
covering a cover layer on the second wiring layer.

16. The fabricating method of claim 14, wherein each of the strain resistor members comprises:
an insulating base substance;
a conductive particle; and
an additive,
wherein when a total amount of each of the strain resistor members is 100 wt %, an usage amount of the insulating base substance is between 8 wt % and 15 wt %, an usage amount of the conductive particle is between 85 wt % and 90 wt %, and an usage amount of the additive is between 0 wt % and 2 wt %.

17. The fabricating method of claim 16, wherein the insulating base substance comprises at least one of epoxy resin, phosphosilicate glass, thermoplastic polyurethane, polyester, polydimethylsiloxane and silicone.

18. The fabricating method of claim 16, wherein the conductive particle comprises at least one of copper, silver, nickel, indium tin oxide, zinc oxide and ruthenium dioxide.

19. The fabricating method of claim 18, wherein the conductive particle further comprises at least one of bismuth, tin, lead and indium.
